(19) United States
(12) Patent Application Publication
(10) Pub. No.: US 2006/0203923 A1
(43) Pub. Date: Sep. 14, 2006

(54) Method and communications system device for the code-modulated transmission of information

(76) Inventors: Elena Costa, Munchen (DE); Ernst Gabidulin, Dolgoprudny (RU); Matthias Lott, Neuried (DE); Victor Pavlushkov, Lund (SE); Egon Schulz, Munchen (DE)

Correspondence Address: STAAS & HALSEY LLP, SUITE 700, 1201 NEW YORK AVENUE, N.W., WASHINGTON, DC, 20005, US

(21) Appl. No.: 10/542,015

(22) PCT Filed: Jan. 8, 2004
(86) PCT No.: PCT/EP04/00074

§ 371 Date: Jan. 17, 2006

(30) Foreign Application Priority Data
Jan. 10, 2003 (EP) 030004261
Jan. 10, 2003 (DE) 103007075

(51) Int. Cl. H04K 1/10

(52) U.S. Cl. 375/260

(57) ABSTRACT

A method for the code-modulated transmission of information in a communications system via a carrier having at least two independent orthogonal resources, uses in particular a frequency band with a plurality of sub-resources as the first resource and the time as the second resource with a sequence of time slots constituting the sub-resource. A code of coded data or information in the form of a two-dimensional matrix is used to assign the information to the individual resources, said matrix having a rank that is greater than or equal to 2. A unique mapping of the code elements to the symbols of an OFDM transmission system is carried out in such a way that transmission errors in both the first sub-resource and the second sub-resource can be reconstructed on the receiver side.

### CROSS REFERENCE TO RELATED APPLICATIONS

This application is based on and hereby claims priority to PCT Application No. PCT/EP2004/000074 filed Jan. 8, 2004 and European Application No. 03000426.1 filed Jan. 10, 2003 and German Application No.103 00 707.5 filed Jan. 10, 2003, the contents of which are hereby incorporated by reference.

### BACKGROUND OF THE INVENTION

The invention relates to a method for the code-modulated transmission of information in a communications system and to a communications system device for carrying out such a method.

A multiplicity of greatly varying communications systems for the transmission of information are generally known, e.g. as defined in the Global System for Mobile Communications (GSM) standard, the Universal Mobile Telecommunications System (UMTS) standard, and in various standards for transmitting data via radio interfaces in mobile data networks (WLAN).

In such communications systems, data or information from a data source is transmitted via a carrier which has at least two independent and mutually orthogonal resources for the transmission of information. In the case of so-called Frequency Division Multiple Access (FDMA), for example, the information is coded and distributed over a multiplicity of different sub-resources in the form of sub-frequencies or sub-frequency bands of the frequency band which is available as a carrier.

In order to prevent the complete loss of transmitted information in the event of poor transmission conditions in a sub-frequency band which has been selected as a resource, codings are used whereby the information is distributed in a coded format over a plurality of sub-resources. The original information can therefore be reconstructed on the receiving side even if one or more transmission errors occur within the domain of the sub-resource.

The so-called Reed-Solomon code is a known example as such a code. In this case, the coding of an information sequence and a modulation result in a signal
S=[u₁, u₂, . . . Uₙ],
where uᵢ, i=1, 2, . . . n are symbols of a modulation method. These symbols usually contain a coded information value, with which further coded information values of the same or a different data source are mixed when orthogonal codes are used. These symbols are then subjected to a frequency modulation such as BPSK, 4-PM or 16-QAM, for example. If the signal which is produced in this way were transmitted via a carrier, it would be impossible to avoid a complete information loss in the event of a burst error. Therefore, using so-called interleaving, a matrix

$$S = [ \begin{matrix}{s}_{1} \\ {s}_{2} \\ ⋮ \\ {s}_{m}\end{matrix} ] [ \begin{matrix}{u}_{1 , 1} & {u}_{1 , 2} & … & {u}_{1 , n} \\ {u}_{2 , 1} & {u}_{2 , 2} & … & {u}_{2 , n} \\ ⋮ & ⋮ & … & ⋮ \\ {u}_{m , 1} & {u}_{m , 2} & … & {u}_{m , n}\end{matrix} ]$$

is created from the signal, where m is an interleaving degree. This matrix is then transmitted column by column via a carrier. If only a few of the columns of the matrix S are lost during the transmission, it is nonetheless possible by virtue of the interleaving to correct the signal and to reconstruct the information on the receiving side on the basis of the attributes of the Reed-Solomon code.

The Reed-Solomon code is a block code which is defined on a Galois field (GF) with 2^{m} symbols. In addition to this structure, scrambling is necessary when using the Reed-Solomon code. However, added to the effort which is required for specifying the code and for the additional scrambling, this procedure has the disadvantage in particular that reconstruction on the receiving side is not possible if a whole column or row of this Galois field is lost. The loss of a frequency sub-carrier can be corrected as a result of the coding and modeling on various frequencies. However, if a whole time slot is lost during the transmission, the information for all the frequency sub-carriers of the corresponding information symbol is missing on the receiving side, thereby making a reconstruction impossible.

A similar problem is presented in the case of space-time coding. If the index m is set for a quantity of sending antennas and the index n is set for a quantity of time slots in the above matrix S, a transmitted signal can again be described as a matrix of the above type. Consequently, in the case of space-time coding, it is again impossible to compensate for the loss of a whole time slot when reconstructing the original information on the receiving side.

Systems which have parallel channels, e.g. TDMA (Time Division Multiple Access), FDMA, etc. with a shared information source and a shared target station or information destination, can generally be described by such a matrix format. The problem is generally one of error correction. If the corruption of a small quantity of columns is the most probable event, a Reed-Solomon coding in combination with interleaving or scrambling is an appropriate solution.

A multiplicity of algorithms for decoding this type of coded information on the receiving side are also generally known, and allow acceptable performance in a multipath environment.

On the other hand, if a single row or just a few rows cannot be transmitted satisfactorily or are lost completely, the Reed-Solomon coding is ineffective because a correspondingly frequent repetition of the transmission of information would be required.

A fundamental idea concerning the use of a so-called rank code for coding information is disclosed by EM Gabidoulin in “Theory of Codes with Maximum Rank Distance, Probl. Inform. Transm. (Problemy Predachi Informatsii)”, vol. 21, No. 1, pp. 1-12, July 1985. This describes vectors which are defined in a linearly dependent manner over a Galois field GF (Q). Simple algorithms are also described for encoding and decoding in this case, with reference to an analogy to Reed-Solomon codes.

A problem here is that a decoding method which is based on a Reed-Solomon decoding method negates the advantages that could actually be produced by using the rank code. Therefore there is no suitable method for implementing the fundamental idea for realistic application conditions in a modern radio communications system.

The possibility of combining OFDM (Orthogonal Frequency Division Multiplexing) and Reed-Solomon codes is generally known from WLAN (Wireless Local Area Network) or HiperLAN2. However, this combination could not be approved during the relevant discussions in the standardization bodies because it offers a poor performance and is resource-intensive with regard to the required interleaving. Instead, a block code or hash code was used for the data networks which are prone to error bursts. The use of Reed-Solomon codes in combination with interleaving is generally known from the GSM mobile radio system.

A suitable combination of coding and modulation has advanced in recent years, in particular due to the introduction of the multi-carrier systems based on Orthogonal Frequency Distribution Multiplex (OFDM) in radio-based communications systems, e.g. DAB, DVB-T and HiperLAN/2 systems. One code technique is the lattice or trellis-coded modulation (TCM), which improves the code performance and system performance by suitably assigning the code words to the modulation alphabet.

However, it is not an easy task to create good codes offering high efficiency with respect to the Hamming/Euclidean distance. One of the main problems relates to managing the frequency-selective fading of the radio channel. A further problem arises if a radio-based communications system is operated in an environment which has pulse-type noises. In this case, many time frames or time slots can be disrupted.

Chih-Hung-Kuo, Chang-Su Kim and C.-C. Jay Kuo describe a method for the integration of a space-time coding in an OFDM system in “Robust Video Transmission over Wideband Wireless Channel Using Space-Time Coded OFDM Systems”, in: Wireless Communications and Networking Conference, 2002, WCNC2002.2002 IEEE, Vol. 2,17-21, March 2002, pp. 931-936. A twofold Reed-Solomon coding is carried out in this case, i.e. a Reed-Solomon coding is carried out for rows first and then a further Reed-Solomon coding is carried out for columns. The coded information of the different columns is then allocated to different sending antennas for transmission. Therefore two consecutive codings are used.

EP 1 032 153 A2 describes a two-stage coding of data for transmission via channels with noise that is subject to pulses. A trellis code modulation is carried out first and then a Reed-Solomon coding. Therefore two consecutive codings are also used in this case.

### SUMMARY OF THE INVENTION

One aspect of the invention addresses the problem of improving a method for the code-modulated transmission of information in such a way that it is possible to compensate for not only transmission errors in a first sub-resource on a receiving side.

The inventors propose a method for the code-modulated transmission of information and a communications system device.

Having as its point of departure the situation of a code-modulated transmission of information in a communications system, in particular a radio communications system, via a carrier comprising at least two independent and mutually orthogonal resources, e.g. a group of sub-frequencies of a frequency band on the one hand and a sequence of time slots from a theoretically infinite sequence of time slots, the coding should take place in a redundant manner such that a transmission error during the transmission is possible on the receiving side in both the first sub-resource e.g. a sub-frequency and the second sub-resource i.e. a specific time slot from a group of time slots. For this, the original information to be transmitted is coded using a code which is at least two-dimensional, and is assigned by the coding to both the sub-resource of the first resource and the sub-resource of the second resource. In this case, code generation is understood to mean a mapping whereby data or information that must be sent is converted into code words by a multiplication using a suitably formed generator matrix. Codes or code words are understood to mean data or information which has been coded in such a way. The code words can be represented in the form of a matrix.

Whereas a one-dimensional code is constructed in the case of e.g. the described Reed-Solomon code, and interleaving or scrambling are additionally required, a two-dimensional matrix-format code is used such that, after coding, the information to be transmitted can be assigned and transmitted via both a quantity of first sub-resources of the first resource and a quantity of second sub-resources of the second resource. Consequently, information or data which allows the reconstruction of the original information is not only assigned to a multiplicity of e.g. sub-frequencies of a frequency band as a first resource, but also to a quantity of e.g. time slots from a group of time slots as a second sub-resource.

The application is therefore possible, in particular, in an OFDM system (OFDM: Orthogonal Frequency Division Multiplex) which is known per se, wherein information to be transmitted is coded and the resulting symbol is supplied to a frequency modulation.

Such a procedure not only has the advantage that error correction in respect of individual errors is possible in both of the resources, but also that the complete loss of a whole sub-resource can be reconstructed on the receiving side, both in the case of the first sub-resource and in the case of the second sub-resource.

A matrix layout having rows for the sub-resources of the first resource and columns for the sub-resources of the second resource is used during code generation. In order to allow error correction, an orthogonal code arrangement is advantageous. Since errors must be compensated in both the first and the second sub-resource, the code that is selected is suitably adapted in relation to the individual code elements of both the first sub-resource and the second sub-resource.

In order to construct a code which satisfies these conditions, a matrix layout is used in which the rank of the matrix or its determinant is greater than or equal to the value two. As a result of establishing the rank as a criterion for the code construction, it is ensured that errors in both the first and second sub-resource can be compensated. This can therefore be referred to as a rank code.

Given a system comprising s rows and r columns, it is possible in principle to reconstruct any number of transmission error patterns, provided the total t of all the incorrect rows s and incorrect columns r is smaller than half of the rank d. This can be expressed as
t=s+r>d/2=(n−k*+1)/2,

where n is the code length and k* is the message length of a (n,k*,d) code which is known per se, d being the rank of the code here. In other words, the redundancy length d of a code which is known per se corresponds in this context to the rank d of the matrix-format code, whereby error correction is possible in both dimensions.

In practice, this allows the correction both of transmission errors in the domain of one or more frequency sub-resources and of transmission errors in the domain of one or more time slots.

When constructing the code over a Galois field (GF) with 2m symbols, the quantity m of the first sub-resource is equal to the quantity of bits per symbol. In this case, the code is defined as a rank code over a Galois field (GF) with ₂m symbols. The second resource, specifically a group of time slots from the theoretically infinite time series, corresponds to the code length per code. In other words, the code length is assigned to a corresponding quantity n of second sub-resources, i.e. time slots.

This procedure can be used in particular when the code elements are assigned one-to-one in each case to a symbol of an OFDM system in the time-frequency domain, the OFDM system being known per se. In principle, however, the transmission on other transmission systems is also possible. For example, the code elements can be assigned one-to-one in each case to a symbol of an orthogonal transmission system in the time-space domain. Even the transmission on a code with more than two dimensions is possible in principle.

A communications system device for carrying out such a method features, in particular, a control entity and a memory for the temporary storage of relevant information and code.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows schematically the assignment of a code word in matrix format to OFDM symbols in the time-frequency domain, and

FIG. 2 shows in greater detail the coding of information with a corresponding communications system device for transmission via a radio interface.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

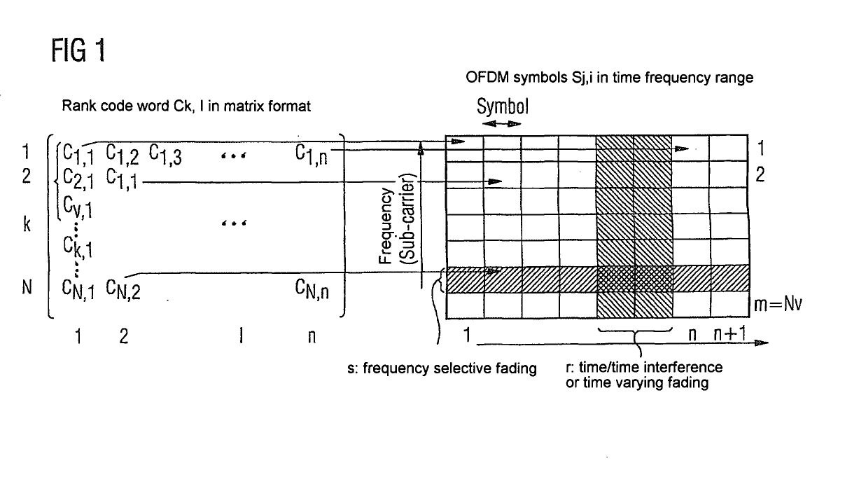

As shown in FIG. 1, a code C is constructed with code elements c_{k,l} in a matrix format, wherein the index k should run from 1 to m and the index I should run from 1 to n. When constructing the code matrix, so-called rank codes are defined over a Galois field (GF) with 2^{m} symbols (GF(2^{m})). The quantity of code words is 2^{(mk*)}, where m is the code power and k* is the message length. Each code word C can therefore be represented in the form of a matrix having the dimensions m×n with binary entries, where n corresponds to the code length and m corresponds to the quantity of bits per symbol. A (n,k*,d) rank code has the rank of at least d in order to allow the error correction for transmission errors in sub-frequency channels and transmission errors in time slots. Such a code consequently allows the correction of any error patterns which can be distributed on s rows and r columns. The following applies for the maximum total number of permitted errors t:
t=s+r<d/2=(n−k*+1)/2.

As shown in FIG. 1, which illustrates a (n,k*,d) rank code in matrix format, a one-to-one mapping of the individual code elements to the OFDM symbols is effected in the time-frequency domain of an OFDM system. In this case, the code length n should be less than or equal to the quantity m of bits per symbol s.

In the simplest embodiment, the data or information dₐ, dₐ₊₁, dₐ₊₂, . . . which must be sent is multiplied with the aid of a suitable specified generator matrix during coding. Entries in the rows of the code word c_{1,1}, c_{2,1}, . . . , c_{j,1}, . . . , c_{m,1}, are then mapped onto the sub-carriers of an OFDM symbol as per a mapping in complex symbols. The sub-carriers correspond to the sub-resource of the relevant frequency domain F, i.e. individual sub-frequencies f₁, f₂, . . . , fⱼ, . . . , fₘ, where j=1, 2, . . . , m. The individual elements of a column of the code matrix C with the coded data dₐ are therefore assigned to various sub-frequencies. On the other hand, the columns of the code matrix are assigned to various symbols s₁, s₂, . . . , sᵢ, . . . , sₙ. That is to say, the elements of a row are distributed over various symbols or time slots i, where i=1, 2, . . . , n.

If a plurality of symbols sᵢ are now disrupted at a time point to e.g. as a result of temporary interferences, or if one or more sub-frequency bands as frequency sub-resource fⱼ are disrupted as a result of e.g. frequency-selective fading over a longer time period, i.e. over a multiplicity of time slots or symbols, use of the rank code makes it possible to overcome these errors on the receiving side. This would not be possible using a standard Reed-Solomon code, which can only efficiently correct one sub-resource, i.e. a small number of disrupted sub-frequency bands.

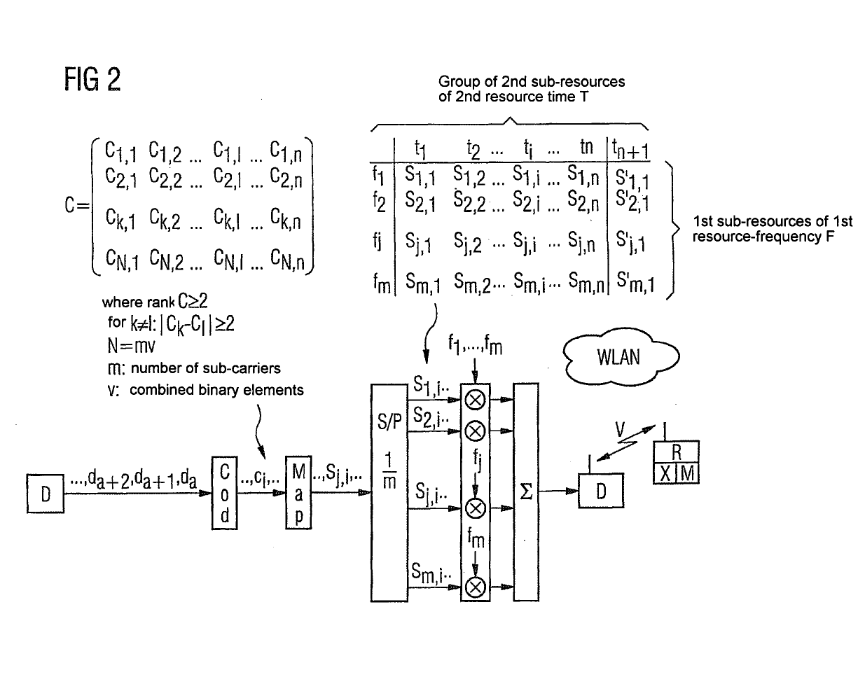

In the described procedure, therefore, a rank code in the form of a matrix is used instead of e.g. a Reed-Solomon code in the form of a vector. This allows a high correction capability despite the use of a matrix having possibly only a very low rank. In particular, the use of Reed-Solomon decoding methods, which would not offer a suitable solution with a satisfactory result, is not also necessary for decoding. The use of a matrix does nonetheless require a suitable mapping, so that the attributes are not lost. An exemplary circuit arrangement for mapping the matrix C for an implementation in an OFDM system is illustrated in FIG. 2.

As shown in FIG. 2, a stream of information or data dₐ, dₐ₊₁, dₐ₊₂, . . . is provided in a timed sequence by a data source D. This data sequence dₐ, dₐ₊ᵢ, dₐ₊₂ is supplied to a coder Cod which effects a coding. The coding takes place by multiplying the data in the data sequence dₐ, dₐ₊₁, dₐ₊₂ using a suitable generator matrix, thereby ultimately producing a data sequence which can be arranged in the form of the code matrix C which are mapped in FIG. 2.

The exemplary code matrix C has rows with n code elements c_{1,1}, c_{1,2}, . . . , c_{1,l}, . . . , c_{1,n} and N columns with code elements c_{1,1}, c_{2,1}, . . . , c_{k,1}, . . . , c_{N,1}, etc. In this case, the code matrix C is subject to the previously described conditions of a rank matrix with a rank greater than 2. Following the multiplication of the information data elements dₐ using the generator matrix, a data stream of code matrix elements c_{k,l} is therefore produced, the data stream being supplied to a mapping or modulation device Map. The actual mapping of the code elements or coded data to the symbols s_{j,i} takes place in this mapping or modulation device Map. It is also easy to execute the coding and the mapping in a single device.

The illustration of the code matrix C and the table with the symbols is shown in the form of matrices in order to demonstrate the principle. It is also easy to perform a serial processing of the individual data values, coded data values and symbols.

FIG. 1 also shows that v binary elements c_{i,1} to c_{v,1} are combined in each case into a complex symbol s_{l,1}, which is then placed on a sub-carrier and processed to form an OFDM symbol. Therefore the code matrix C normally has more rows than the symbol matrix.

Following the mapping and modulation in the mapping device Map, a sequence of so-called symbols s_{j,i} is produced, where j=1, . . . m is an index for the parallel lines in each case and i=1, . . . n is an index for the various elements of the time-based resource tᵢ.

The symbols s_{j,i} are then supplied to a serial-to-parallel conversion device S/P which has m parallel data lines as output. The symbols s_{j,i} are output on these parallel data lines in such a way that the symbols which are assigned to a row of the code matrix C or symbol matrix are output consecutively on a corresponding one of the output lines. The symbols s_{j,i} of each data line are then supplied to a modulation stage in which a frequency modulation is performed on each of the individual parallel lines, wherein each line is assigned a dedicated frequency fⱼ, where j=1, . . . , m are sub-resources of the second carrier resource frequency F. The resulting data after the modulation is totalized in a manner which is known per se, and transferred to e.g. a radio interface V for transmission to a receiver R. The receiver R can be, for example, a mobile or stationary terminal which conforms to the WLAN standard. The receiver R features a control entity X and a memory M which are suitably designed for decoding the received coded data. In particular, a corresponding matrix for decoding the code C or the generator matrix is stored in the memory M.

Using this arrangement, an allocation of the individual code elements c_{k,l} of the code C, i.e. the coded data dₐ, to the symbols s_{j,i} is coordinated in such a way that each code element c_{k,l} is assigned to a symbol s_{j,i} on a one-to-one basis.

When specifying the code C in the form of a code matrix with the coded data, it is established as an initial condition that the rank should correspond to at least D/2, so that in the case of a rank of 2 it is at least possible to correct either an error within a row or a transmission error within a column. This corresponds to the correction of a transmission error due to the failure of either a part of or a complete sub-resource of the first carrier resource frequency, i.e. a frequency channel, or of the second carrier resource time, i.e. a time slot tᵢ.

The higher the rank d of the matrix of the code C, the greater the number of transmission errors that can be corrected on the receiving side. In this case, the use of a code in the form of a rank code allows the correction of any of the error patterns which could be distributed on the rows and columns. These are shown by way of example for the sequence of symbols s_{j,i}.

It is therefore proposed to combine rank codes with the OFDM transmission technique which is known per se. In this case, rank codes are constructed over extended Galois fields GF(2^{m}). The maximal distance of a (n,k*,d) rank code is defined by d=n−k*+1 in this case. The quantity of code words is 2^{(mk*)}. Each code word can be represented as a matrix having the dimensions m×n with binary entries, where n is the code length. If a (n,k*,d) rank code is being considered, every code matrix C unequal to zero has at least the rank d. This allows the correction of any error patterns which are distributed in any s rows and in any r columns of the matrix, provided that the total number of errors is t=s+r<d/2=(n−k*+1)/2 as a maximum.

In comparison with a (n,k*,d) Reed-Solomon code having the same parameters, the code words c_{k,l} of the rank code can be represented as the matrices having the dimensions m×n with binary entries. In addition, a code matrix unequal to zero has at least d columns unequal to zero in the case of the Reed-Solomon code. However, this only allows the correction of errors which occur in t<d/2 columns. If all errors are arranged in a single row and the number of errors is greater than (d−1)/2, however, the decoding fails in the case of the Reed-Solomon method. By contrast, in the proposed rank code method, at least d rows having values unequal to zero are also present, and therefore the original information is redundantly distributed over both a plurality of rows and a plurality of columns of an orthogonal system before the transmission via the radio interface V.

Each binary code matrix is depicted as a binary character string, e.g. by column. In this case, it can be assumed that a configuration of the size q=2^{v} is used, where e.g. v=2 in the case of QPSK. For the purpose of a 16-QAM modulation, e.g. q=16 and v=4. The character string is subdivided into sequential sections of length v, wherein each section is mapped onto the assigned signal of the configuration.

When considering an OFDM system having m carriers and a modulation configuration of the size q, a parameter N=mv is selected. A code matrix is then modulated as a sequence of n time frames or time slots in accordance with the conditions of the rank code. It is therefore possible for a plurality of time frames, e.g. (n−k*)/2, to be seriously disrupted as a result of co-channel interference or extremely correlated fading. In this case, both rank codes and Reed-Solomon codes could correct these errors. However, if even one single sub-carrier fⱼ of the other resource F is disabled during the whole of the code word duration, a Reed-Solomon code cannot correct such an error, whereas a rank code can. Moreover, a method which uses a rank code does not require an interleaver or, in the worst case, only requires an interleaver with a low interleaving degree.

A use of rank codes is particularly advantageous in the case of an OFDM transmission technique for the transmission of high data speeds in future radio-based systems of the fourth generation. Furthermore, rank codes offer a protection against unauthorized accesses without a corresponding change of coding and decoding.

In the context of this procedure, the second resource i.e. the theoretically infinite time series is therefore grouped in such a way that, for each code C, a grouping of the time-based sub-resource tᵢ is performed such that each group of time-based sub-resources tᵢ has the same quantity of elements as the code length of the code.

The invention has been described in detail with particular reference to preferred embodiments thereof and examples, but it will be understood that variations and modifications can be effected within the spirit and scope of the invention covered by the claims which may include the phrase “at least one of A, B and C” or a similar phrase as an alternative expression that means one or more of A, B and C may be used, contrary to the holding in Superguide v. DIRECTV, 69 USPQ2d 1865 (Fed. Cir. 2004).

1-13. (canceled)

14. A method for code-modulated transmission of information in a communications system via a carrier which has at least two independent and mutually orthogonal resources with a first resource having first sub-resources and a second resource having second sub-resources, comprising:
coding the information to be transmitted into a code, said code being at least two-dimensional, wherein
the code is constructed in accordance with a matrix layout having rows and columns, and
the code is constructed such that the matrix has a rank greater than or equal to the value 2; and
assigning the code to first and second sub-resources.

15. The method according to claim 14, wherein
a complete loss of a whole sub-resource as a transmission error can be compensated for by reconstructing the matrix at a receiver, and
the receiver can compensate for a loss of a whole first sub-resource or a loss of a whole second sub-resource.

16. The method according to claim 14, wherein
the code is constructed in accordance with a matrix layout having rows for the first sub-resources and having columns for the second sub-resources.

17. The method according to claim 14, wherein
the code is assigned in a redundant manner such that both a transmission error in a first sub-resource and a transmission error in a second sub-resource can be compensated for on the receiving side.

18. The method according to claim 17, wherein
distributed transmission errors on s rows and r columns can be compensated for if the total number t of incorrectly transmitted rows and columns is smaller than half the rank of the matrix.

19. The method according to claim 18, wherein
the total number t of incorrectly transmitted rows s and columns r, for which compensation is possible, is defined as follows:
t=s+r<d/2=(n−k*+1)/2
where n is a length of the code, k* is a message length of the code and d is the rank of the code.

20. The method according to claim 19, wherein
the rank d of the code corresponds to a redundancy length of the code.

21. The method according to claim 14, wherein
the code is assigned to a quantity m of first sub-resources, and
the quantity m of first sub-resources is equal to the quantity of bits per symbol of a Galois field which has 2^{m} symbols.

22. The method according to claim 14, wherein
the code is a rank code over a Galois field which has 2^{m} symbols.

23. The method according to claim 14, wherein
the code is assigned to a quantity n of second sub-resources, and
the quantity n of second sub-resources corresponds to a length of the code.

24. The method according to claim 14, wherein
the code has elements, which are assigned on a one-to-one basis to symbols of an OFDM system in a time-frequency domain.

25. The method according to claim 14, wherein
the code has elements, which are assigned on a one-to-one basis to symbols of an orthogonal transmission system in a time-frequency domain such that different columns of the matrix represent different time slots and different rows of the matrix represent different frequencies.

26. The method according to claim 15, wherein
the code is constructed in accordance with a matrix layout having rows for the first sub-resources and having columns for the second sub-resources.

27. The method according to claim 26, wherein
the code is assigned in a redundant manner such that both a transmission error in a first sub-resource and a transmission error in a second sub-resource can be compensated for on the receiving side.

28. The method according to claim 27, wherein
distributed transmission errors on s rows and r columns can be compensated for if the total number t of incorrectly transmitted rows and columns is smaller than half the rank of the matrix.

29. The method according to claim 28, wherein
the total number t of incorrectly transmitted rows s and columns r, for which compensation is possible, is defined as follows:
t=s+r<d/2=(n−k*+1)/2
where n is a length of the code, k* is a message length of the code and d is the rank of the code.

30. The method according to claim 29, wherein
the rank d of the code corresponds to a redundancy length of the code.

31. The method according to claim 30, wherein
the code is assigned to a quantity m of first sub-resources, and
the quantity m of first sub-resources is equal to the quantity of bits per symbol of a Galois field which has 2^{m} symbols.

32. The method according to claim 31, wherein
the code is a rank code over a Galois field which has 2^{m} symbols.

33. The method according to claim 32, wherein
the code is assigned to a quantity n of second sub-resources, and
the quantity n of second sub-resources corresponds to the length of the code.

34. The method according to claim 33, wherein
the code has elements, which are assigned on a one-to-one basis to symbols of an OFDM system in a time-frequency domain.

35. The method according to claim 34, wherein
the code has elements, which are assigned on a one-to-one basis to symbols of an orthogonal transmission system in the time-frequency domain such that different columns of the matrix represent different time slots and different rows of the matrix represent different frequencies.

36. A communications system device for the code-modulated transmission of information in a communications system comprising:
at least one input for information;
a memory device to temporarily store the information and a code, which is at least two dimensional, formed by coding the information;
a control entity to code the information in accordance with a matrix having a rank greater than or equal to the value 2; and
an output to transmit a signal modulated with the code.
